(19) United States
(12) Patent Application Publication
(10) Pub. No.: US 2006/0050980 A1
(43) Pub. Date: Mar. 9, 2006

(54) Image processing apparatus, electronic camera, scanner, and image processing method

(75) Inventor: Atsushi Kohashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 11/218,593

(22) Filed: Sep. 6, 2005

(30) Foreign Application Priority Data
Sep. 9, 2004 (JP) 2004-262230

(51) Int. Cl. G06K 9/40

(52) U.S. Cl. 382/254

(57) ABSTRACT

An image processing apparatus which calculates noise values based on signal levels of image signals and, reduces based on the noise values, the noise included in image signals which is output from a subject image sensor, including: a noise value output unit which, takes a certain image sensor as a baseline image sensor, stores correspondence relations between signal level values and noise values of output signals from the baseline image sensor, and outputs as first noise values the noise values of the baseline image sensor corresponding to signal level values of the image signals based on the correspondence relations; and, a noise value correction unit which compensates the first noise values to obtain second noise values corresponding to the subject image sensor using a prescribed variable which relates the noise characteristics of the baseline image sensor and of the subject image sensor.

### BACKGROUND OF THE INVENTION

1. Field of the Invention

This invention relates to an image processing apparatus, electronic camera, scanner, and image processing method to reduce the noise included in image signals.

Priority is claimed on Japanese Patent Application No. 2004-262230, filed Sep. 9, 2004 the content of which is incorporated herein by reference.

2. Description of the Related Art

In image processing apparatuses which enhance the image quality of image signals obtained from a CCD (Charge Coupled Device) or other image sensor through digital image processing, noise reduction processing, in which the noise in the image is reduced, is one type of processing performed to enhance image quality.

There are various causes of noise in images, however, noise arising from the image sensor has a particularly great effect. The principal components of noise occurring in an image sensor are dark current noise and shot noise. Dark current noise is noise caused by heat, and occurs even when the image sensor is not receiving light. This dark current noise is substantially constant in volume regardless of the area of the image, and because this is added to what the image of the object originally should be, the brightness of the image as a whole is increased, and in particular causes a problem in which the black level in the image does not reach to a certain level that is the level defined as black in data, for example zero.

On the other hand, shot noise occurs due to statistical fluctuations occurring at the time of photoelectric conversion, and appears as random noise in an image. Because degree of the fluctuation is proportional to the square root of the number of photons, the greater the number of photons, that is, the greater the quantity of incident light on the image sensor, the larger degree of the shot noise itself. For example, if the image signal output level value is 100 for the quantity of incident light at 100, then there is the possibility that shot noise may occur at a level of 10, therefore, the output level of the image signal fluctuates between 90 and 110. When the quantity of incident light is 10,000, the shot noise value is 100, and so the output level value fluctuates between 9,900 and 10,100.

In general, it is more difficult to reduce shot noise than to reduce dark current noise, and the noise level is also higher, so that the shot noise component has a large impact on the image. As explained above, shot noise is related to the number of photons, so that in addition to the light intensity, the amount of shot noise occurrence also changes depending on the area per pixel of the image sensor, and also changes with the photoelectric conversion characteristics and color filter characteristics of the image sensor. That is, the amount the shot noise is different for each image sensor, and is not determined simply.

FIG. 8 shows the relation of the amount of the shot noise to the quantity of the incident light for each color filter of a certain image sensor, as measured by the inventors. The larger the quantity of the incident light, that is, the higher the image signal level, the greater is the shot noise value, and characteristics are also different for each RGB color filter.

Hence when reducing noise occurring due to the image sensor, a method is conceivable in which characteristic of the quantity of the incident light and shot noise is measured in advance for each image sensor and color filter, and the shot noise reduction is processed based on this characteristic. For example, in Japanese Unexamined Patent Application, First Publication, No. 2001-157057, a technique is disclosed in which constant terms a, b, c, which are given as static, and a signal level converted into a density value D are used to express the noise level N as the function N=ab^{cD}, the noise level N is estimated for a signal level D from this function, and based on the estimated noise level N, the filtering frequency characteristic is controlled. By this means, adaptive noise reduction processing is performed on the signal level.

### SUMMARY OF THE INVENTION

The first aspect of the present invention is an image processing apparatus which calculates noise values based on signal levels of image signals and, reduces based on the noise values, the noise included in image signals which is output from a subject image sensor, including: a noise value output unit which, takes a certain image sensor as a baseline image sensor, stores correspondence relations between signal level values and noise values of output signals from the baseline image sensor, and outputs as first noise values the noise values of the baseline image sensor corresponding to signal level values of the image signals based on the correspondence relations; and, a noise value correction unit which compensates the first noise values to obtain second noise values corresponding to the subject image sensor using a prescribed variable which relates the noise characteristics of the baseline image sensor and of the subject image sensor.

The second aspect of the present invention is the image processing apparatus according to the first aspect, wherein the noise value output unit comprises a lookup table which stores the correspondence relation between signal level values for output signals from the baseline image sensor and the first noise values.

The third aspect of the present invention is the image processing apparatus according to the first aspect, wherein the noise value output unit includes: a register which stores the correspondence relation between a plurality of signal level values of output signals from the baseline image sensor and the first noise values corresponding to the signal level values; and a noise value interpolation circuit which generates and outputs the first noise values for arbitrary signal level values by processing interpolation calculations using the first noise values corresponding to the plurality of signal level values which are stored in the register.

The fourth aspect of the present invention is the image processing apparatus according to the first aspect, wherein the noise value correction unit includes: a first register which stores a first prescribed value relating the noise characteristics of the baseline image sensor and of the subject image sensor; a second register which stores a second prescribed value relating the noise characteristics of the baseline image sensor and of the subject image sensor; a multiplier which multiplies the first prescribed value stored in the first register by the first noise value output from the noise value output unit; and an adder which adds the second prescribed value stored in the second register to the multiplication result of the multiplier, or, a subtracter which subtracts the second prescribed value from the multiplication result.

The fifth aspect of the present invention is an electronic camera, including: an image sensor which converts light incident through a lens into electrical signals; an image processing apparatus according to the first aspect, which reduces noise included in output signals from the image sensor; and, an external output unit, which converts signals output from the image processing apparatus into a prescribed format and outputs the signals to an external apparatus.

The sixth aspect of the present invention is a scanner, including: an image sensor whose pixels are arranged in one direction; an image processing apparatus according to the first aspect, which reduces noise included in output signals from the image sensor; and an external output unit, which converts signals output from the image processing apparatus into a prescribed format and outputs the signals to an external apparatus.

The seventh aspect of the present invention is an image processing method, in which noise values are calculated based on signal levels of the image signals, and the noise included in the image signals output from subject image sensor is reduced based on the noise values, including steps of: outputting, taking a certain image sensor as a baseline image sensor and storing correspondence relation between signal level values of output signals from the baseline image sensor and noise values, as first noise values the noise values of the baseline image sensor corresponding to the signal level values of the image signals based on the correspondence relation; and correcting the first noise values to second noise values corresponding to the subject image sensor using a prescribed variable which relates the noise characteristics of the baseline image sensor and of the subject image sensor.

### BRIEF DESCRIPTION OF THE DRAWINGS

FIG. 1 is a block diagram showing the configuration of the image processing apparatus of a first embodiment of the invention;

FIGS. 2A-FIG. 2E are reference drawings used to explain the operation of the data generation portion in the first embodiment;

FIG. 3 is a block diagram showing the configuration of the noise value correction portion of the first embodiment;

FIG. 4 is a flowchart showing the operation of the image processing apparatus of the first embodiment;

FIG. 5 is a block diagram showing the configuration of a representative noise characteristic storage portion of the first embodiment;

FIG. 6 is a block diagram showing the configuration of the electronic camera of a second embodiment of the invention;

FIG. 7 is a block diagram showing the configuration of the scanner of a third embodiment of the invention; and,

FIG. 8 is a graph showing measured results for a shot noise characteristic.

### DETAILED DESCRIPTION OF THE INVENTION

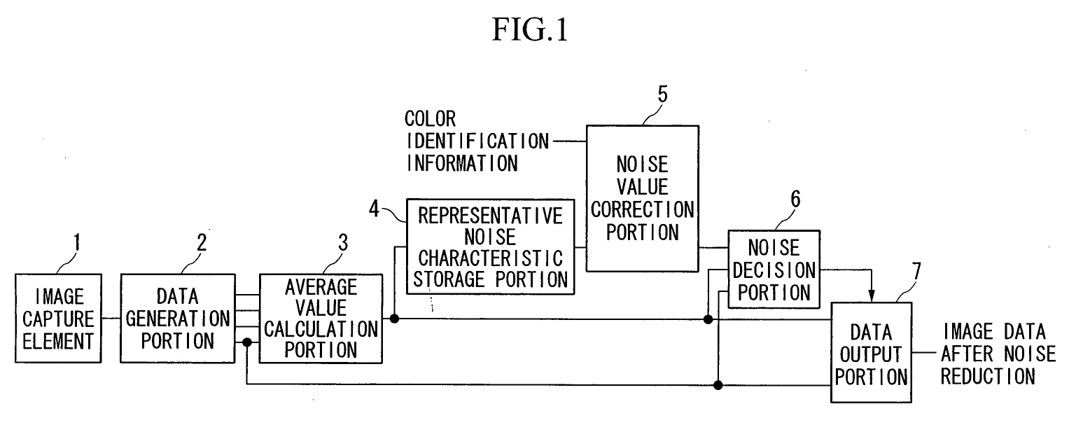

Below, preferred embodiments of the invention are explained, referring to the drawings. FIG. 1 is a block diagram showing the configuration of the image processing apparatus of a first embodiment of the invention. Below, each of the components in the drawing is explained. The image sensor 1 converts light incident through a lens which is not shown on the figure, into electrical signals, which are output as image signals. The data generation portion 2 converts image data into n×m two-dimensional image data, based on image signals input, one pixel at a time, from the image sensor 1. The average value calculation portion 3 calculates the average value of the two-dimensional image data.

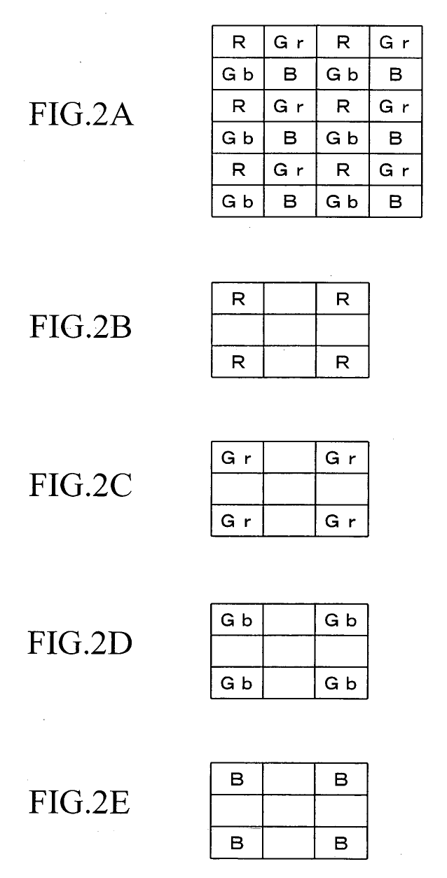

Here, FIG. 2 is used to explain the color filter array of the image sensor 1. In FIG. 2A is one example of a color filter of an image sensor, and is called a Bayer RGB filter. Here, R, Gr, B, Gb respectively represent red, green in the same row as red, blue, and green in the same row as blue. When using an image sensor with this color filter installed, four pixels output by the data generation portion 2 are one of the color patterns in FIG. 2B through FIG. 2E.

The representative noise characteristic storage portion 4 stores as representative a noise characteristic which is the correspondence relation between signal level values of output signals from an image sensor used as baseline and noise values (hereafter called “first noise values”), and outputs a first noise value corresponding to the signal level value of an average value signal from the average value calculation portion 3. The noise value correction portion 5 uses a first noise compensation value which is a second prescribed value and a second noise compensation value which is a first prescribed value, and which relate the noise characteristics of the image sensor taken as reference and the image sensor 1, to compensate the noise characteristic which is output from the representative noise characteristic storage portion 4 to the noise characteristic which is intrinsic to the image sensor 1. The noise decision portion 6 judges whether or not to perform noise reduction for a subject pixel. The data output portion 7 selects output data based on decisions by the noise decision portion 6.

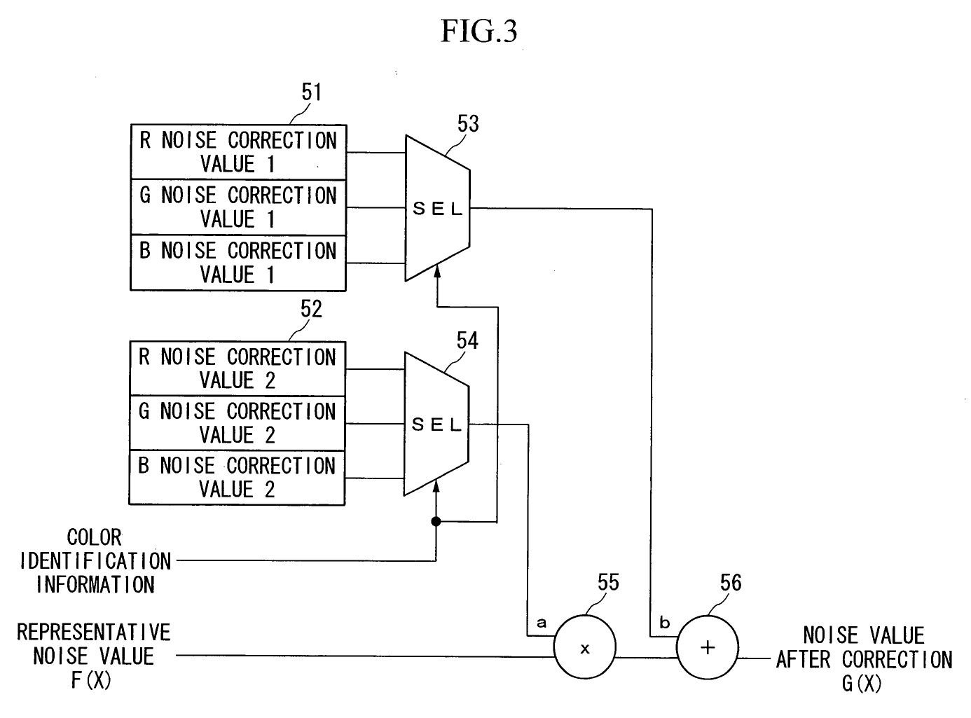

FIG. 3 is a block diagram showing the configuration of the noise value correction portion 5. The noise value correction portion 5 is configured utilizing the fact of the relation described below between the representative noise characteristic and the characteristic of the image sensor 1. That is, if the first noise value when the input image brightness is x is F(x), the first noise compensation value is b, and the second noise compensation value is a, then the noise value G(x) of the image sensor 1 (hereafter called the “second noise value”) is calculated as follows.
G(x)=a×F(x)+b (1)

As explained above, shot noise in an image sensor is proportional to the square root of the number of photons, therefore, the characteristics F(x) and G(x) will both be characteristics of power operation like that in FIG. 8, and by performing computations using equation (1) based on the linearity between the two, a representative noise characteristic can be converted into the characteristic for the image sensor 1.

Specifically, in FIG. 3 the registers 51 store first noise compensation values b and in which three registers are provided for each of the RGB signals. The registers 52 store the second noise compensation values a, and again three registers are provided for the three RGB signals. The selector 53 switches between the first noise compensation values b based on color identification information indicating the color of the pixel being processed. The selector 54 switches between the second noise compensation values a based on color identification information. The multiplier 55 multiplies the first noise value which is output from the representative noise characteristic storage portion 4 and which is corresponding to the image sensor taken as baseline, with the second noise compensation value a which is switched by the selector 54. The adder 56 adds the result of multiplication by the multiplier 55 with the first noise compensation value which is switched by the selector 53. In place of the adder 56, a subtracter may be provided.

The first and second noise compensation values can be determined as follows. Because equation (1) is a binominal linear equation, if the first noise values F(x1) and F(x2) and the second noise values G(x1) and G(x2) are known for two input image brightnesses x1, x2, then a and b can be determined. The selection of x1 and x2 is arbitrary, however, for example, by applying a small value to x1 and a large value to x2, it becomes possible to combine noise characteristics for both bright areas and for dark areas; or, two points can be selected at brightnesses at which accurate noise reduction is especially important. In this way, for each image sensor, it is sufficient to perform only the measurements necessary to calculate the first and second noise compensation values.

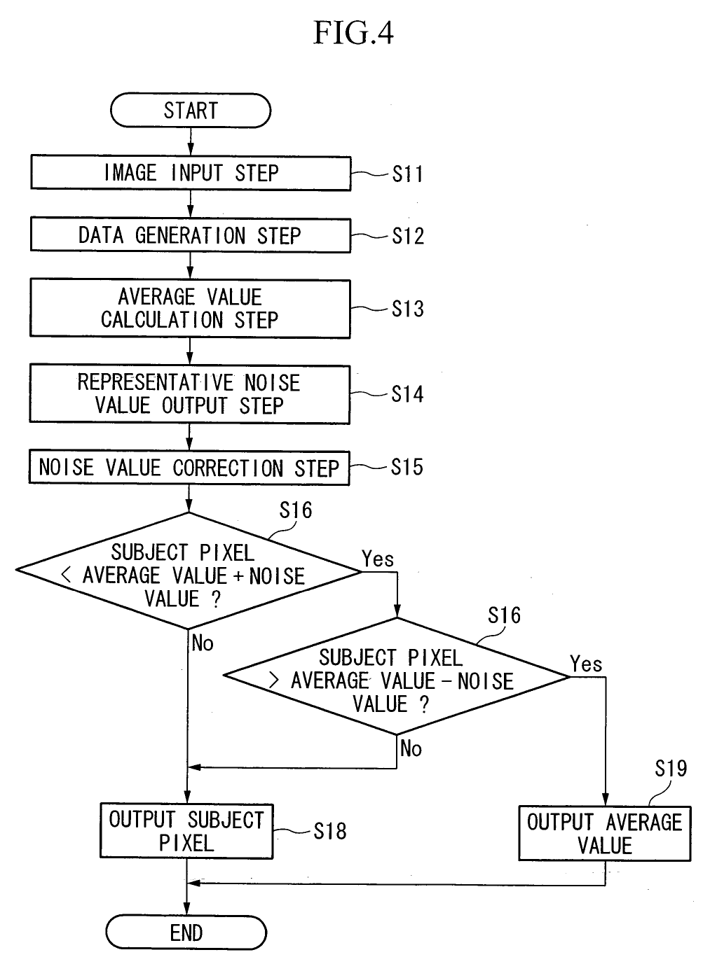

Next, operation of the image processing apparatus of this embodiment is explained referring to the flowchart of FIG. 4. First, image data resulting from photoelectric conversion by the image sensor 1 is A/D converted (not shown on the figure), and the digital image data which is converted is input, one pixel at a time, to the data generation portion 2 (step S11). The data generation portion 2 converts the image data, input one pixel at a time, into 3×3 two-dimensional image data, and as shown in FIG. 2, outputs the four pixels in the four corners (step S12).

Following this, the average value calculation portion 3 calculates the average-value signal of the four pixels output from the data generation portion 2 (step S13). For example, when the output from the data generation portion 2 is the R pixels of in FIG. 2A, the value output is obtained by adding the signal values for the four R pixels and dividing by four. However, because in this embodiment the data generation portion 2 outputs four pixels, the average value calculation portion 3 calculates the simple average of four pixels; but the data generation portion 2 can output an arbitrary number of pixels of the same color, and in this case it is acceptable that the average value calculation can be a weighted average rather than a simple average.

Next, the representative noise characteristic storage portion 4 takes as input the average-value signals which is output from the average value calculation portion 3, and outputs a first noise value corresponding to the image sensor serving as baseline (step S14). A characteristic for any one color among noise characteristics already measured in advance, such as for example those shown in FIG. 8, is stored in the representative noise characteristic storage portion 4, and based on this noise characteristic, a first noise value (vertical axis of the graph in FIG. 8) corresponding to the input average-value signal (horizontal axis of the graph in FIG. 8) is output. Here, the noise characteristic stored in the representative noise characteristic storage portion 4 need not necessarily be the noise characteristic of the image sensor 1, but may be any noise characteristic of an image sensor which can be used with the image processing apparatus to perform this noise reduction processing.

Next, the noise value correction portion 5 corrects the first noise value output by the representative noise characteristic storage portion 4 so as to become the second noise value of the image sensor 1 which is actually used (step S15). In this step, the selector 53 of the noise value correction portion 5 outputs the first noise compensation value for the color indicated by the color identification information. And, the selector 54 outputs the second noise compensation value for the color indicated by the color identification information. The multiplier 55 multiplies the representative noise value output from the representative noise characteristic storage portion 4 with the second noise value, and outputs the result. The adder adds and outputs the output from the multiplier 55 and the first noise compensation value.

Next, the noise decision portion 6 decides whether or not noise reduction should be processed to the subject pixel (steps S16 and S17). Here, the subject pixel is the pixel on which noise reduction processing is to be performed, and refers to one of the pixels among the four pixels in FIG. 2B through FIG. 2E, which is output from the data generation portion 2. The noise decision portion 6 makes a decision for this subject pixel using the following two criteria. In this decision, the level of the subject pixel is the signal level of one pixel among four pixels output from the data generation portion 2. The average value is the average-value signal level calculated by the average value calculation portion 3. The noise value is the second noise value after correction, output from the noise value correction portion 5.
Level of subject pixel<(average value+noise level) (1)
Level of subject pixel>(average value−noise level) (2)

The meanings of these two decisions are as follows. The average value on the right-hand side of the decision formulae can be regarded as the signal from which frequency components such as random noise have been excluded, that is, as the signal not containing noise. The noise value is the shot noise value arising when the output from the image sensor is at the level of the average-value signal. Hence, the average value+noise value of (1) can be considered as the upper limit of the pixel level when noise is contained in the subject pixel. That is, if the decision result for (1) is true, that is, if the level of the subject pixel is lower than the average value plus the noise value, then this result indicates a high probability that the subject pixel contains a shot noise component. Conversely, if the result is false, then this result indicates that while noise may be contained, the subject pixel is in a portion at which the level change is greater than the noise value, such as for example at an edge portion of an object.

Similarly for the decision of (2), a true result indicates that noise is contained, and a false result indicates that the pixel is in an area with large changes in level. If the result of the logical product of these two decision results is P, then:
when P is true, the subject pixel contains a noise component, and moreover is in a flat portion of the image; and,
when P is false, the subject pixel contains a noise component, and moreover is in an edge portion of the image.

By processing such decisions, it is possible to accurately discriminate among pixels at which the level change in the image is due to noise, and pixels at which the level change is due to an object, so that as a result, accurate noise reduction processing can be processed. In this embodiment, a configuration is adopted in which one among the average-value signal and the signal of the subject pixel is output as the output signal of the noise reduction processing, but other configurations are possible, and any method may be employed so long as noise is reduced based on the noise characteristic, measured in advance, of an image sensor. Moreover, an example of a Bayer RGB filter was used as the color filter of the image sensor in the explanation, but of course other filters may be used.

In step S16, the noise decision portion 6 performs the decision of (1). If the decision result is true, that is, if the level of the subject pixel is lower than the average value plus the noise value, then processing advances to step S17. If the decision result is false, that is, if the level of the subject pixel is equal to or higher than the average value plus the noise value, then the noise decision portion 6 decides that the subject pixel is at an edge portion, and outputs to the data output portion 7 a signal indicating output of the subject pixel. Based on this signal, the data output portion 7 outputs the signal for the single pixel output from the data generation portion 2 (step S18).

In step S17, the noise decision portion 6 performs the decision of (2). If the decision result is false, that is, if the level of the subject pixel is equal to or lower than the average value minus the noise value, processing advances to step S18, and operation is that for the case in which the subject pixel is in an edge portion. If the decision result is true, that is, if the level of the subject pixel is greater than the average value minus the noise value, then because (average value+noise value)>level of subject pixel>(average value−noise value), the noise decision portion 6 decides that the subject pixel is not in an edge portion of the image, and so outputs to the data output portion 7 a signal indicating output of the average value. Based on this signal, the data output portion 7 outputs the average-value signal output from the average value calculation portion 3 (step s19). The above-described operation is repeated upon each input of a pixel signal from the image sensor 1.

Any method may be used to store first noise values in the representative characteristic storage portion 4 in this embodiment. For example, a LUT (lookup table) method using memory may be employed, or a noise characteristic curve may be divided into a number of straight lines, and parameters for the straight lines stored in a register, or interpolation computations may be used to determine first noise values. The noise characteristic for one image sensor is stored in the memory or register, so that the memory size or register bit length can be fixed. Further, a noise characteristic which has been stored need not be overwritten, so that a ROM or other small-scale storage element can be used.

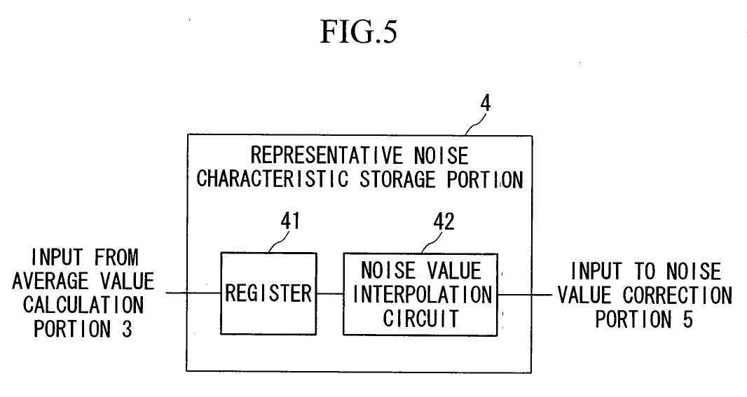

FIG. 5 is a block diagram showing the configuration of a representative noise characteristic storage portion 4, when a noise characteristic curve is divided into a number of straight lines, and interpolation calculation is used to determine first noise values. In the drawing, the register 41 is a register in which are stored multiple signal level values of output signals for the image sensor used as baseline, and parameters for straight lines connecting points on a noise characteristic curve indicating the correspondence relation between the first noise values and the corresponding signal level values. The noise value interpolation circuit 42 calculates first noise values corresponding to input values of the representative noise characteristic storage portion 4 through interpolation calculation using parameters stored in the register 41, and outputs the result as the output of the representative noise characteristic storage portion 4.

The image processing apparatus of the above-described embodiment may be realized by recording a program on computer-readable recording media which realizes these operations and functions, and by causing a computer to read and execute the program recorded on this recording media.

Here, if the WWW system is being used, “computer” provides home page environments (or display environments). “Computer-readable recording media” includes flexible media, magneto-optical discs, ROM, CD-ROM and other transportable media, and hard disks and other storage devices incorporated within a computer. And, “computer-readable recording media” further includes media which holds the program for a fixed length of time, such as volatile memory (RAM) in a server or client computer system, when the program is transmitted over the Internet or another network or over telephone circuits or other communication circuits.

The above-described program may also be transmitted from a computer storing the program in a storage device or similar to another computer, either via transmission media or by means of transmission waves in transmission media. Here, the “transmission media” transmitting the program is media such as the Internet or another network (communication network), or telephone line or other communication circuits (communication lines), having functions for transmission of information. The above-described program may also be used to realize a portion of the above-described functions. Further, the program may be used in combination with a program already recorded on a computer to realize the above-described functions, as a so-called differential file (differential program or libraries and so on).

By means of the above-described embodiment, a representative noise characteristic storage portion 4 is provided which stores the noise characteristic of a certain image sensor, taken as baseline; using a prescribed variable which relates the noise characteristics of this image sensor and those of the image sensor 1, first noise values of the image sensor taken as baseline, corresponding to the output from the image sensor 1, are converted into second noise values for the image sensor 1, and using these second noise values, noise reduction is processed. Hence the size of the storage element for storing the first noise values can have a small and inexpensive configuration, and moreover noise reduction processing corresponding to various image sensors can be performed.

Further, it is sufficient to perform measurements in order to calculate only the first and second noise compensation values for each individual image sensor, so that a noise reduction processing device can be realized without increasing the unit cost of the equipment (such as a digital camera) into which this noise reduction processing is incorporated.

When the representative noise characteristic storage portion 4 is configured by means of a LUT, the first noise value can be set precisely according to the input brightness. On the other hand, when the representative noise characteristic storage portion 4 is configured by means of a register 41 storing parameters for each of the several straight lines into which the noise characteristic curve is divided and a noise value interpolation circuit 42 which calculates first noise values through interpolation calculation, the circuit scale can be made still smaller.

As shown in FIG. 3, in the noise value correction portion 5, a register 51 which stores first noise compensation values relating the noise characteristics of the image sensor used as baseline and the image sensor 1, and a register 52 which stores second noise compensation values are provided, and the representative noise value and second noise compensation values are multiplied, and the first noise compensation value is added to or subtracted from the multiplication result, therefore, by means of a simple circuit configuration, the noise characteristic of an image sensor serving as baseline which is stored in the representative noise characteristic storage portion 4, can be converted into the noise characteristic of the image sensor 1 which is actually used. Moreover, it is necessary to measure, as parameters intrinsic to the image sensor which is used, only the first noise compensation value and second noise compensation value, so that noise characteristics can be measured by simple means.

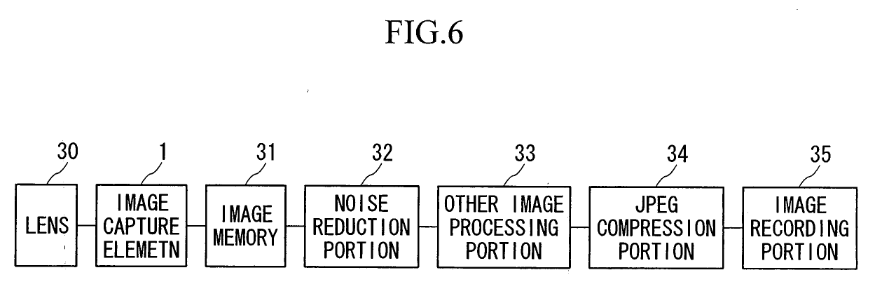

Next, a second embodiment of the invention is explained. FIG. 6 is a block diagram of a configuration for a case in which the image processing apparatus of the first embodiment is applied to an electronic camera. In FIG. 6, the lens 30 focuses incident light on the light-receiving face of the image sensor 1. The image memory 31 is memory to store image data output from the image sensor 1. The noise reduction portion 32 has a configuration similar to that of the first embodiment (data generation portion 2 through data output portion 7), and processes noise reduction. The other image processing portion 33 performs image processing other than noise reduction, such as for example color correction, brightness correction, and resolution correction. The JPEG compression portion 34 performs JPEG compression of images. The image recording portion 35 stores images on a memory card or similar.

Below, operation of the electronic camera of this embodiment is explained. An object image focused by the lens 30 on the image sensor 1 is photoelectrically converted by the image sensor 1, and after A/D conversion (not shown in the figure), the result is stored in the image memory 31. In the noise reduction portion 32, noise reduction is processed to image data which is read from the image memory 31, through the operation described in the first embodiment, and various other image processing is performed by the other image processing portion 33. Then, the image is compressed by the JPEG compression portion 34 and is stored in the image recording portion 35. By means of the above configuration, an electronic camera can be realized which is capable of obtaining high-quality images in which noise has been reduced.

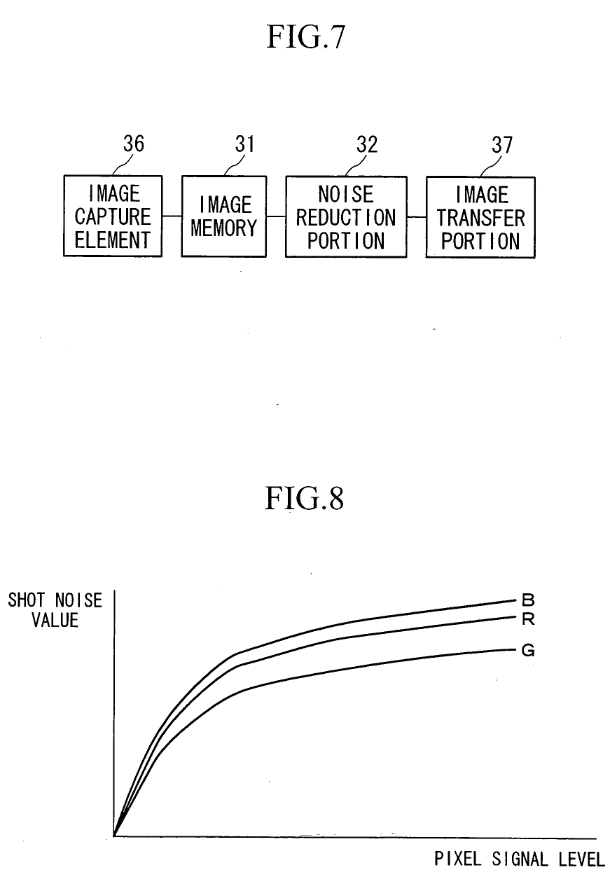

Next, a third embodiment of the invention is explained. FIG. 7 is a block diagram showing the configuration for a case in which the image processing apparatus of the first embodiment is applied to a scanner. In FIG. 7, constituent components similar to those in FIG. 6 are assigned the same symbols, and explanations are omitted. The image sensor 36 is an image sensor in which pixels are arranged in one direction. The image transfer portion 37 converts the image into a prescribed format and transfers the image to external equipment.

Below, operation of the scanner of this embodiment is explained. Image data which is scanned by the image sensor 36 which moves in one direction is A/D converted (not shown in the figure), and is then stored in the image memory 31. In the noise reduction portion 32, noise reduction is processed to image data which is read from the image memory 31, through the operation explained in the first embodiment. Then, the image data is transferred to external equipment by the image transfer portion 37. By means of the above configuration, a scanner capable of obtaining high-quality images with noise reduced can be realized.

In the above, embodiments of this invention have been explained in detail referring to the drawings; however, specific configurations are not limited to these aspects, and various design modifications which do not deviate from the gist of this invention are also included.

According to this invention, means are provided for storing the noise characteristic of a certain image sensor which is to serve as baseline, and using a prescribed variable which relates the noise characteristics of the certain image sensor and another image sensor 1, the noise value of the image sensor to serve as baseline corresponding to the output of the image sensor 1 is converted into the noise value of the image sensor 1, and this noise value is used to reduce the noise level. Hence there is the advantageous result that the noise levels of various image sensors can be reduced using an inexpensive construction.

What is claimed is:

1. An image processing apparatus which calculates noise values based on signal levels of image signals and, reduces based on the noise values, the noise included in image signals which is output from a subject image sensor, comprising:
a noise value output unit which, takes a certain image sensor as a baseline image sensor, stores correspondence relations between signal level values and noise values of output signals from the baseline image sensor, and outputs as first noise values the noise values of the baseline image sensor corresponding to signal level values of the image signals based on the correspondence relations; and,
a noise value correction unit which compensates the first noise values to obtain second noise values corresponding to the subject image sensor using a prescribed variable which relates the noise characteristics of the baseline image sensor and of the subject image sensor.

2. The image processing apparatus according to claim 1, wherein the noise value output unit comprises a lookup table which stores the correspondence relation between signal level values for output signals from the baseline image sensor and the first noise values.

3. The image processing apparatus according to claim 1, wherein the noise value output unit comprises:
a register which stores the correspondence relation between a plurality of signal level values of output signals from the baseline image sensor and the first noise values corresponding to the signal level values; and
a noise value interpolation circuit which generates and outputs the first noise values for arbitrary signal level values by processing interpolation calculations using the first noise values corresponding to the plurality of signal level values which are stored in the register.

4. The image processing apparatus according to claim 1, wherein the noise value correction unit comprises:
a first register which stores a first prescribed value relating the noise characteristics of the baseline image sensor and of the subject image sensor;
a second register which stores a second prescribed value relating the noise characteristics of the baseline image sensor and of the subject image sensor;
a multiplier which multiplies the first prescribed value stored in the first register by the first noise value output from the noise value output unit; and
an adder which adds the second prescribed value stored in the second register to the multiplication result of the multiplier, or, a subtracter which subtracts the second prescribed value from the multiplication result.

5. An electronic camera, comprising:
an image sensor which converts light incident through a lens into electrical signals;
an image processing apparatus according to claim 1, which reduces noise included in output signals from the image sensor; and,
an external output unit, which converts signals output from the image processing apparatus into a prescribed format and outputs the signals to an external apparatus.

6. A scanner, comprising:
an image sensor whose pixels are arranged in one direction;
an image processing apparatus according to claim 1, which reduces noise included in output signals from the image sensor; and
an external output unit, which converts signals output from the image processing apparatus into a prescribed format and outputs the signals to an external apparatus.

7. An image processing method, in which noise values are calculated based on signal levels of the image signals, and the noise included in the image signals output from subject image sensor is reduced based on the noise values, comprising steps of:
outputting, taking a certain image sensor as a baseline image sensor and storing correspondence relation between signal level values of output signals from the baseline image sensor and noise values, as first noise values the noise values of the baseline image sensor corresponding to the signal level values of the image signals based on the correspondence relation; and
correcting the first noise values to second noise values corresponding to the subject image sensor using a prescribed variable which relates the noise characteristics of the baseline image sensor and of the subject image sensor.
